(19) United States
(12) Patent Application Publication
(10) Pub. No.: US 2007/0086839 A1
(43) Pub. Date: Apr. 19, 2007

(54) Securing tool with swing clip and indicia area

(76) Inventor: Linda R. Pollock, Minnetonka, MN (US)

Correspondence Address: Curtis D. Kinghorn;Sirius Strategic, LLC, 6769 W. Shadow Lake Dr., Lino Lakes, MN, 55014, US

(21) Appl. No.: 11/528,148

(22) Filed: Sep. 26, 2006

Related U.S. Application Data
(60) Provisional application No. 60/720,635, filed on Sep. 26, 2005.

(51) Int. Cl. B42F 13/12

(52) U.S. Cl. 402/64

(57) ABSTRACT

The present invention is a device and method for organizing papers or similar elements. This is accomplished through the combination of a swing clip mechanism with a device for locating paper or similar elements such as binder pocket divider, binder cover, pocket folio, adjustable book cover, multi-paged binder, attachable unit or any other similar device. The swing clip mechanism secures the paper or similar elements to the device for locating paper or similar elements. In this way, the inherent organizing capacity of the device for locating paper or similar elements is improved and enhanced because the paper or other similar elements are securely positioned with respect to the device for locating paper or similar elements.

This application claims the benefit of U.S. Provisional Application No. 60/720,635, filed Sep. 26, 2005.

### BACKGROUND OF THE INVENTION

1. Field of the Invention

This invention relates to devices and methods for organizing products and more specifically to devices for organizing products using a swing clip mechanism.

2. Description of Related Art

Organizing is not a skill that is taught in school. For some, organization comes naturally, but for many people, trial and error is the method of learning how to get organized. Without the guidance of a peer, co-worker, or even a Professional Organizer, people who are disorganized tend to turn to organizational tools to resolve their disorganizational issues. Those tools can include books and videos, but most often the first action a person with organizational issues takes is to look for “the perfect organizing tool” to solve their dilemma. The perfect organizing tool does not exist, but there are vital key elements that will increase the likelihood of a person's success; it must be easy to implement, easy to use and have a method of identification or an area to include the identification.

When a person is looking at a tool to help them get organized, they either see marketing materials, displays or other people's systems showing the product in its end use form, or they imagine what it will do for them. Once they acquire the organizing tool and find it takes more than a few simple steps to implement, discouragement quickly sets in and the person sets the product aside. Unless there is a huge motivating factor, the product typically stays unused from this point forward. If it is easy to implement, then the next crucial hurdle to overcome is ease of use.

Ease of use refers to many factors: is it easy to understand how to use; does it function like it is supposed to; does it function well, such as opening and closing with ease; is it durable enough to withstand the use; does it continue to work the way it is supposed to on a long-term basis; does it take a minimal number of steps to use; is it easy to use. A product that appears perfect initially quickly loses its effectiveness if any one of the ease of use elements are absent.

The third vital element to an effective organizing tool is having the ability to identify the contents contained by the tool. People organize either visually or kinesthetically. A visual organizer must keep everything visible and in view, while a kinesthetic person must somehow interact with the item before putting it away. Visual people rely heavily upon visual cues for identifying contents; colors, shapes and, most importantly, labels. The indicia serves as a visual cue, reminding them of the content of the product. For a kinesthetic person, hands on interaction is crucial. Even though indicia serves as a reminder of the content, it is the act of writing or producing the indicia that is vital to their recall.

One such invention that appears to have the elements necessary for an organizing tool to be effective is disclosed in U.S. Pat. No. D442,631. The '631 patent shows a planar member having a swing clip attached to its upper surface. The planar member has a series of holes with openings extending to the edge of the planar member from the holes. The holes correspond to the location of binder rings so that the binder rings interact through the holes to hold the planar member in a binder. Because the holes have openings extending from the holes to the edge of the planar member, it is relatively easy to install by pushing the binder rings through the openings to the holes, thereby negating the need to open and the then close the binder rings through the holes. The swing clip facilitates ease of use. But the same element that allows the device to be easy to install, in this case open slotted three ring holes, is also its liability. As papers are added to the swing clip and the weight increases, the open three ring design allows the entire unit to easily fall out of the binder. As a result, the product does not continue to work the way it is supposed to. Another crucial element to be very useful as a tool for organizing that is absent from this design is that it lacks a space for indicia. And, as a functional feature, this product also does not include a pocket. The open three ring holes prevents a pocket from being added, as it, too, would increase the weight and likelihood of product failure.

U.S. Pat. No. 6,261,021 shows a binder insert having a clip. The binder insert has holes for allowing binder rings from a standard binder to pass through to hold the binder insert in the binder. The '021 patent also shows these holes being closed, i.e, not having openings leading from the holes to the edge of the binder insert. This closing of the holes addresses the above mentioned issue of product failure but the disclosed device falls short in the ease of use and indicia categories. To use this embodiment of a binder insert having a clip, the end user must use two hands and take multiple steps to insert papers into the holder, which includes trying to hold up two clips at one time while inserting paper. The clips do prevent the papers from falling out, but they also prevent the person from being able to see the documents located under the clips. Because of the breadth of the clips, the end user cannot flip through contents located under the clips. To view documents, a person has to remove the paper for viewing and then re-insert the paper back into this embodiment. Visibility is also limited in that documents are located inside the folder, not externally. This product falls extremely short in the ease of use category and, does not include a place for indicia.

In looking at organizing tools by broad category, one can readily see limitations in each type of product. In the binder category, there are numerous patents and products. Where people struggle with binders is in the ease of implementation. Securing information into a binder takes too many steps. First, the page has to be punched, which stops many if they don't have ready access to a hole punch, plus it destroys the structure of the paper. The cover has to be opened, as does the ring mechanism, which often requires a two to three step process. Finally the person can insert the paper, but they need to be sure to not catch their fingers when the ring mechanism closes. Odd sized papers make the process even more daunting. So, to avoid all the steps, many users simply shove the paper inside the cover or into a pocket. Pockets are known for crumpling corners, binder material makes the type printing stick and unsecured papers fall out. Binders are a great tool, once they are set up, but the process of securing papers needs to be simplified.

If a person does not want the hassle of a binder, they have the option of using a folder. With folders, the paper maintains its non-holed integrity, but documents slide around in the pockets and the materials can be easily damaged if a person is not careful when inserting and removing documents. In addition, pockets limit the size of the contents, both in quantity and in physical size. Small papers get lost in folders. When looking at the ease of use criteria, pockets do not continue to work well on a long-term basis.

For students, the accepted organizational tool is a binder or folder. But many use their book cover as a paper holder instead. A book cover serves to identify and protect the book but, because it is easy to implement, many students shove paper between the covers. The resulting consequences are that papers fall out, get lost or get destroyed because books are not designed to function as a binder. Several patents address the topic of an adjustable book cover, and many succeed within a limited scope. Where they fall short is that the majority of designs require the book cover to wrap around the book in its entirety or to slide onto the side of the front cover. Other patents have added features such as a pocket or sleeve, but, the adjustability issue has to be addressed first, or the student won't implement the system.

Another organizational tool, most commonly used in the medical industry, is a mounted multi-paged binder system. The system consists of a mounting system, multiple pages of sheet protectors and indicia. Where the current system falls short is that the information is located inside the sheet protector pages and is difficult to remove. As with binders, they work well when they are set up, but implementing the system and then keeping it current requires too many steps.

Finally, another organizational tool that appears from kitchens to the office is that of a magnetic or push pin nature. Limitations for both can be found in the ease of use category. Magnets are limited in the number of papers they hold, they loose their ability to stick, the materials can easily slide down the surface if bumped, and all the papers come loose when the magnet is removed. In the case of push pins on a bulleting board, people tend to put things up and then add more, without removing the prior contents. The person, especially a visual organizer, wants visible access to a number of papers, but the size of the bulletin board and depth of the push pin prevent multiple quantities. After many layers have built upon the board, visibility has decreased and it becomes more difficult to remove information from the lower levels. The content is often placed randomly upon the board, based on open space and there is no method of adding indicia.

Even though there appears to be many categories of tools addressed, they are all missing a key element in at least one of the categories; easy to implement, easy to use and the need for a place to identify the content.

### SUMMARY OF THE INVENTION

The present invention is a device and method for organizing papers or similar elements. This is accomplished through the combination of a swing clip mechanism with a device for locating paper or similar elements such as binder pocket divider, binder cover, pocket folio, adjustable book cover, multi-paged binder, attachable unit, clipboard or any other similar device. The swing clip mechanism secures the paper or similar elements to the device for locating paper or similar elements. In this way, the inherent organizing capacity of the device for locating paper or similar elements is improved and enhanced because the paper or other similar elements are securely positioned with respect to the device for locating paper or similar elements.

The invention is described through the use of illustrative embodiments that address the three key elements to organization. Some of the objects and advantages of the invention in one or more of these embodiments are as follows:

It is an objective of the invention in one or more embodiments to provide organizing products that are effective.

It is an objective of the invention in one or more embodiments to provide organizing products that are easy to implement.

It is an objective of the invention in one or more embodiments to provide organizing products that are easy to use.

It is an objective of the invention in one or more embodiments to provide organizing products that include a space for indicia to meet the needs of both the visual and kinesthetic organizer.

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

### BRIEF DESCRIPTION OF THE DRAWINGS

FIG. 1 is a front view of a swing clip.

FIG. 2 is a front view of an embodiment of the invention having a binder pocket divider.

FIG. 3 is a perspective view of the invention of FIG. 2 binder pocket divider attached to a binder.

FIG. 4 is a back view of the invention of FIG. 2.

FIG. 5 is a front view of the invention of FIG. 2 with dual tabs.

FIG. 6 is a front view of a binder with an outside top swing clip mechanism and tab.

FIG. 7 is a front view of a binder with an outside top swing clip mechanism.

FIG. 8 is a front view of side swing clip mechanism on the front of a binder having a cover sheet.

FIG. 9 is a front view of top swing clip mechanism on the front of a binder having a cover sheet.

FIG. 10 is a front view of the cover sheet open on the front of the binder.

FIG. 11 is a front view of a pocket folio with an inside top swing clip mechanism.

FIG. 12 is a front view of a pocket folio with multiple clips.

FIG. 13 is a front view of a binder with a ring mechanism and an inside side swing clip mechanism.

FIG. 14 is a front view of an adjustable book cover with a top swing clip mechanism and tab.

FIG. 15 is a back view of an adjustable book cover.

FIG. 16 is a side view of an adjustable book cover.

FIG. 17 is a perspective view of an adjustable book cover attached to a book.

FIG. 18 is a front view of a single attachable page of the multi-paged binder.

FIG. 19 is a front view of a multi-paged binder with top clips and a desktop stand apparatus.

FIG. 20 is a front view of a multi-paged binder with top clips and a wall mounting apparatus.

FIG. 21 is a front view of an attachable unit with clip.

FIG. 22 is a side view of an attachable unit with a swing clip mechanism and a magnetic backing.

FIG. 23 is a side view of an attachable unit with a swing clip mechanism with attaching pins.

FIG. 24 is a side view of an attachable unit with a swing clip mechanism with an attaching clip.

FIG. 25 is a front view of a clipboard with a swing clip mechanism attached.

### DETAILED DESCRIPTION OF THE INVENTION

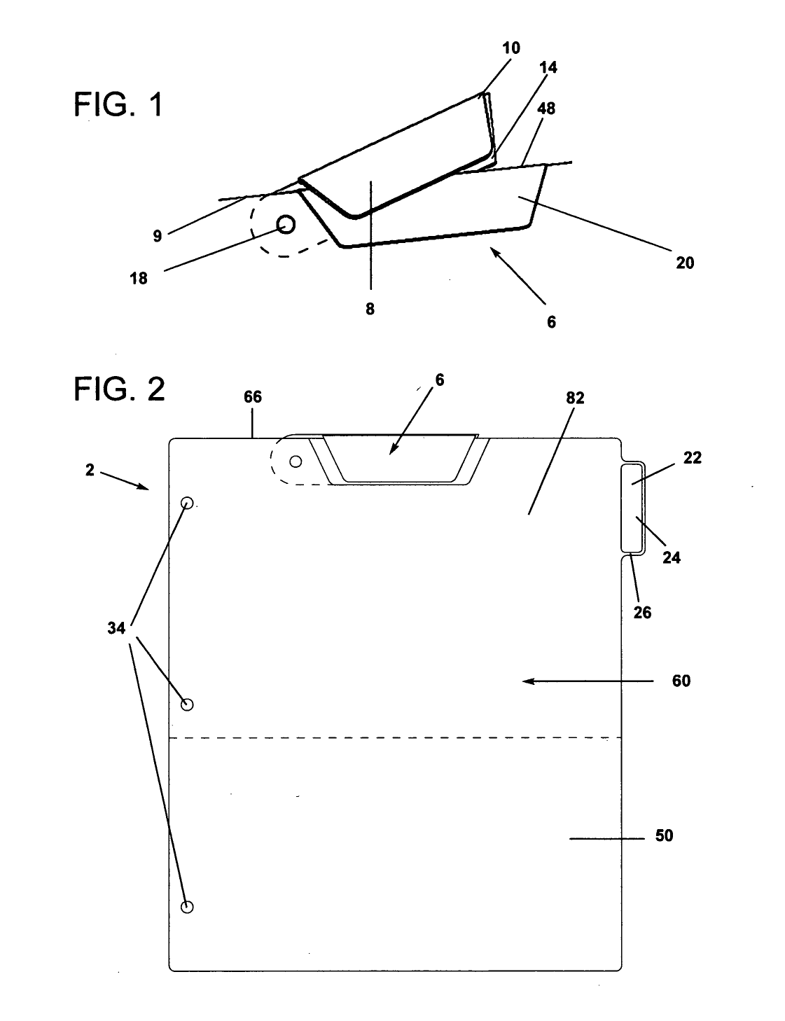

The invention described herein and shown in FIGS. 1-25 is generally referenced by the reference number 2. The invention 2 combines at least one swing clip mechanism 6, such as is well known in the art, with various devices such as a binder 76 or book 78 or an attachable unit 74 to attach a swing clip mechanism 6 to a flat surface 80. As will be explained in detail hereafter, the invention also preferably includes indicia 22 that serves as a visual cue reminding the user of the content of the product. Because of the ease of use of a swing clip mechanism 6 for securing papers to a binder 76, book 78 or flat surface 80 and the importance of creating order utilizing indicia 22, multiple embodiments of the swing clip mechanism 6 and indicia 22 combination are disclosed below.

Prior to disclosing embodiments of the invention 2, it is important to note three components required to make a swing clip mechanism 6 work effectively. FIG. 1 shows the combination of components that make up a swing clip mechanism 6: a clip 8, rivet 18 and rollover tab 20. The clip 8 also includes a top portion 10 and a bottom portion 14. First, the clip 8 must be movable with respect to the rollover tab 20, generally by means of a rivet 18 connected through one end of the clip 8. Second, the material 9 that the clip 8 is connected to needs to be sturdy enough so that the material 9 won't tear after repeated use of the swing clip mechanism 6 and yet be flexible enough to allow for ease of movement of the clip 8. In the office organizing product's industry, the most durable material 9 currently available is polypropylene. But, other durable and flexible materials may also be used for material 9 such as, but not limited to, fiberboard, metal, pressboard, cardboard, paper, composite materials, ceramic, plastics and wood. All of the embodiments in this application were designed with a flexible material 9 in mind.

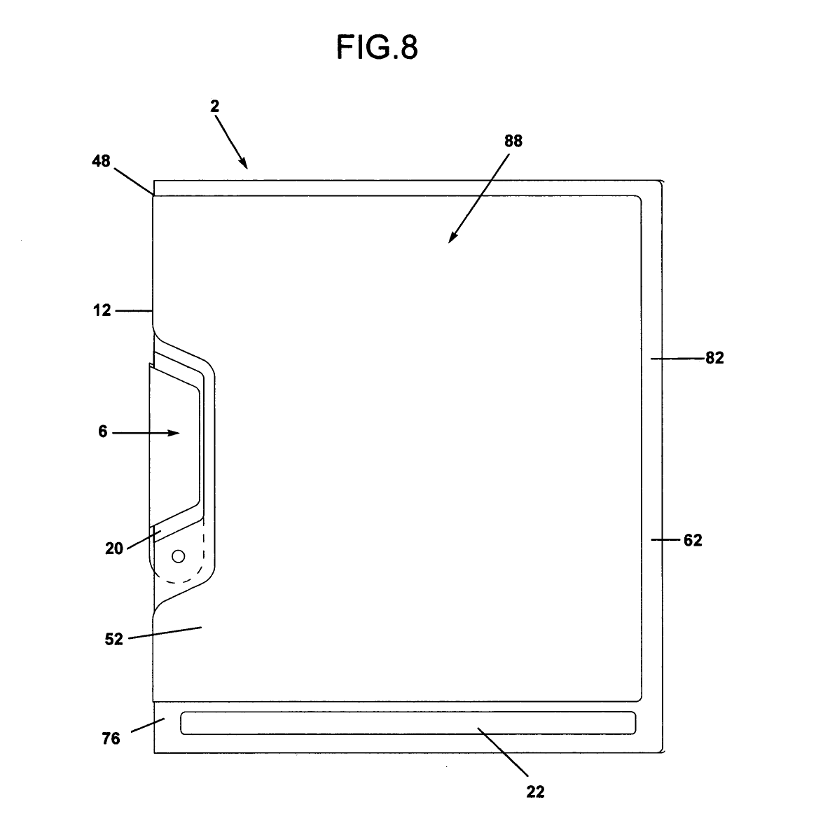

Third, and most important, for a swing clip mechanism 6 to be effective, there is preferably a rollover tab 20 that fits inside the clip 8. The rollover tab 20 is the mechanism that allows the clip 8 to adjust itself to hold varying amounts of paper or other material and is made by die cutting the shape of a rollover tab 20 and adding a fold 48 as described below (FIGS. 8-10) prior to attaching the clip 8 to the material 9.

Rollover tab 20 is preferably made of a low-friction material that allows the paper or similar elements to slide over it as the clip 8 is applied. In practice, rollover tab 20 is often an integral part of the material 9 and “rolled over” to lie under the clip 8 so that it will lie on the material 9 but be located between the paper or similar elements and the material 9. Although it is desirable to form the rollover tab 20 as an integral part of the material 9, rollover tab 20 may be separately formed and located so as to allow the paper or other similar material to slide over it instead of contacting the material 9 when the clip 8 is applied.

The breadth of the clip 8 usually can be as small as about 5 cm and go up to about 16 cm, depending upon design preference while the length of clip 8 usually is about 2 to 4 cm and the depth is anywhere from about 0.1 cm up to about 1.3 cm. Of course, these dimensions can be varied larger or smaller depending on the application. The top 10 portion of the clip 8 typically has a wider breadth and the clip 8 typically slopes inward so the bottom 14 portion is a narrower breadth.

FIGS. 2, 3, 4 and 5 show an embodiment of the invention 2 including a binder pocket divider 60 having a top 66, bottom 67, a tab 26 that has an area for indicia 22 with an optional write and erase surface 24, a pocket 50, and an attaching mechanism 34. The invention in this embodiment combines the binder pocket divider 60 with a swing clip mechanism 6 located on the top 66 of the binder pocket divider 60. The swing clip mechanism 6 is attached to the top 66 of the binder pocket divider 60 by the rivet 18 or similar means that allows the clip 8 to pivot around the rivet 18 or the similar means.

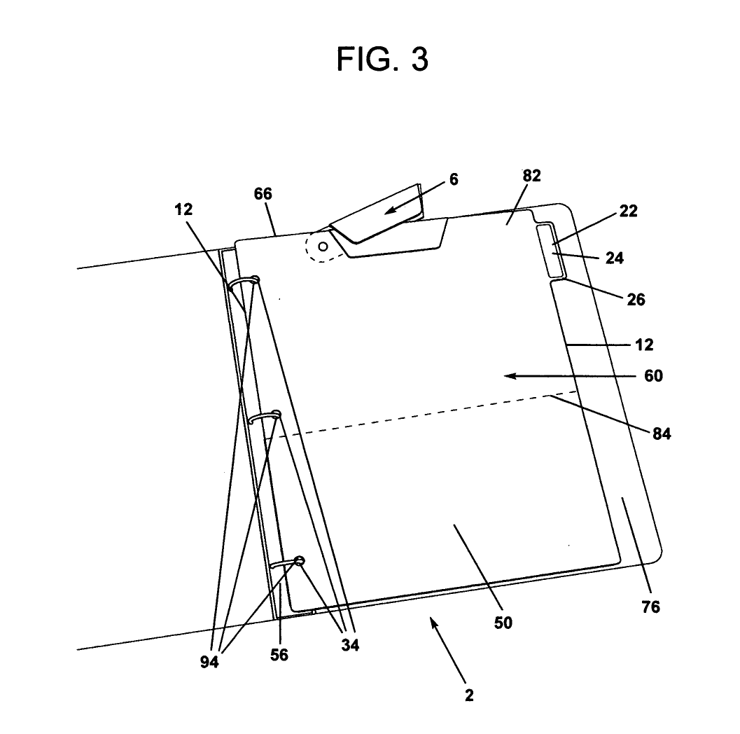

FIG. 3 is a perspective view of the embodiment of the invention 2 shown in FIG. 2 with the binder pocket divider 60 attached to a binder 76. The binder pocket divider 60 is preferably designed to fit into industry standard two or three ring binders 76. As a result, the overall dimensions of the binder pocket divider 60 typically would have a breadth of about 22 to 24 cm and a length of about 27 to 30 cm. Further, the binder pocket divider 60 also preferably has an attaching mechanism 34 such as a series of holes corresponding to the location of the binder's 76 ring mechanism 56 to secure the binder pocket divider 60 to the binder's 76 ring mechanism 56. In FIG. 3, the attaching mechanism 34 displayed is three holes 94. From the top 66 of the binder pocket divider 60, the hole 94 centers are at approximately 3 to 4 cm, 14 to 15 cm and about 24 to 26 cm down with the holes 94 being indented from the side 12 approximately about 1 cm to 2 cm which dimensions are standard for papers or other members to be attached to the ring mechanism 56 of a binder 76 as is well understood in the art.

The swing clip mechanism 6 is centered on the top 66 of the binder pocket divider 60. The pocket 50 is typically located on either the front 82, back 84 or both of the binder pocket divider 60 and typically has dimensions of about 9 to 15.3 cm in length and a depth from about 0.8 to 2 cm.

As mentioned about, the binder pocket divider 60 preferably has a tab 26. The function of the tab 26 is to hold indicia 22 that serves as a visual cue reminding the user of the content of the product. The tab 26 for indicia 22 is preferably located on the top 66 or side edge 12 of the binder pocket divider 60. Tab 26 typically ranges in length from about 1 cm up to about 26 cm and preferably includes a write and erase surface 24 for writing on to indicate the contents of the documents stored in the binder pocket divider 60.

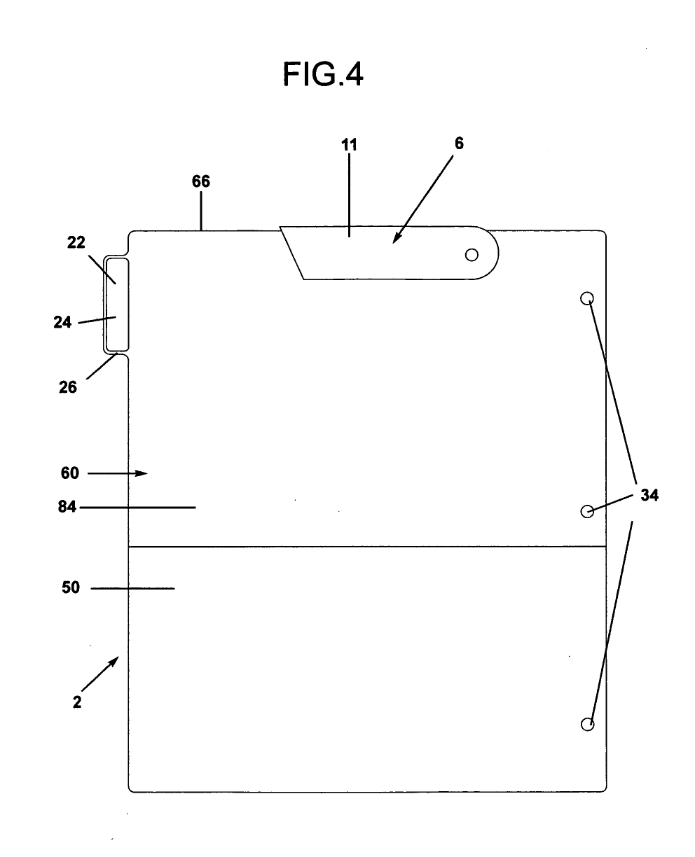

FIG. 4 is a back view of the binder pocket divider 60 showing the back 84 of the binder pocket divider 60. The back 11 of the swing clip mechanism 6 attaches to the back 84 at the top 66 of the binder pocket divider 60. Typically, the side of the tab 26 facing in the same direction as the back 84 also has an area for indicia 22 with an optional write and erase surface 24. As mentioned above, back 84 may also include a pocket 50. Further, the attaching mechanism 34 will typically also manifest itself on back 84.

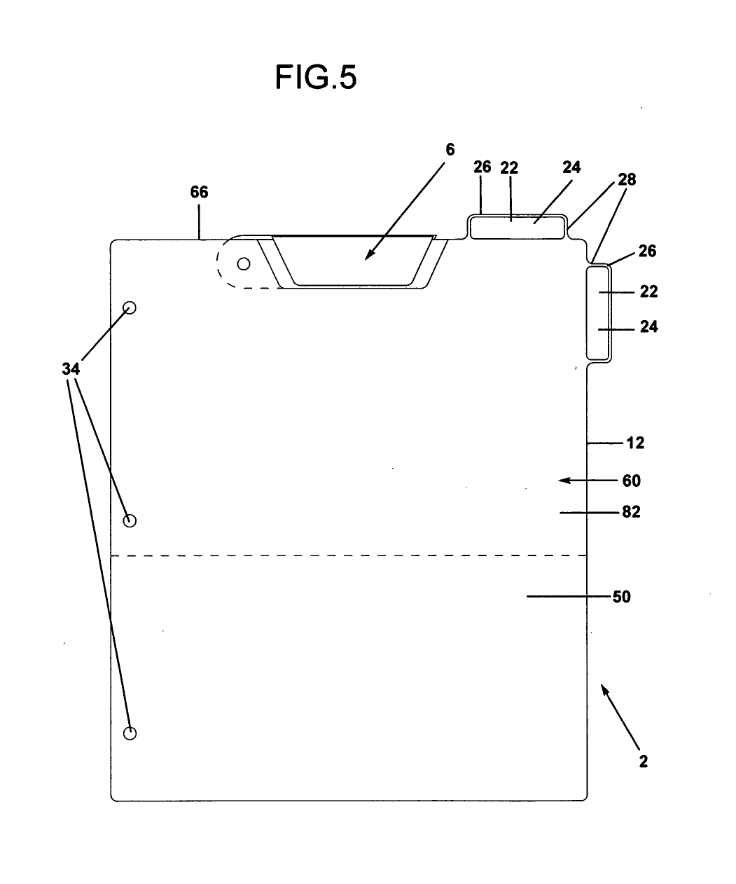

FIG. 5 is a front view of the front 82 of the binder pocket divider 60 in an embodiment having dual tabs 28. As in previous embodiments, the binder pocket divider 60 consists of a swing clip mechanism 6 located on the top 66 of the binder pocket divider 60, at least one pocket 50 and an attaching mechanism 34. In addition, this embodiment has dual tabs 28, each in the form of a tab 26 as described above and preferably with both tabs 26 having an area for indicia 22 with an optional write and erase surface 24. The tabs 26 of dual tabs 28 are preferably located along the top 66 and the side edge 12 of the binder pocket divider 60.

The embodiment of the invention 2 shown in FIGS. 2-5 and described above is easy to implement. The binder pocket divider 60 only has to be inserted into a binder 76 one time and is clear to the user how to use it. This embodiment of the invention is easy to use because the swing clip mechanism 6 only requires one hand to use, the number of steps required to insert a paper are minimal, the end user does not require a paper punch for inserting the paper into the binder and documents can be easily removed. From a structural stand point, the integrity of the document can be maintained, various sized papers can easily be secured into the binder 76, the embodiment of the invention 2 is secured in the binder 76 by means of closed ring holes, the material of the binder pocket divider 60 is durable and the design does not require a cover sheet 52 to hold the papers in resulting in reduced manufacturing costs. There is at least one space for indicia 22, with the option of adding dual or staggered tabs 26 to the embodiment so both the visual and kinesthetic organizers can have their needs met.

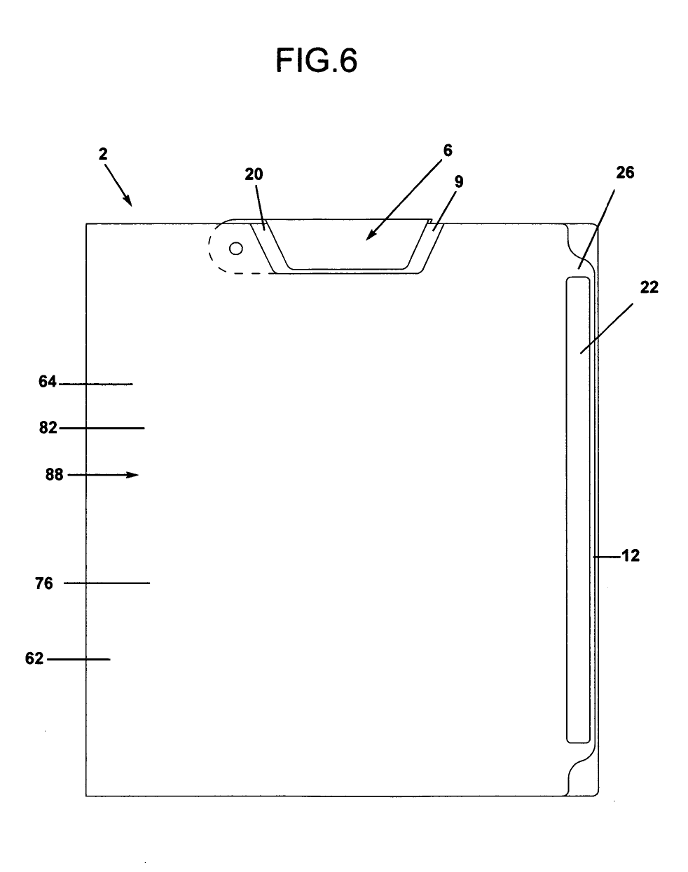

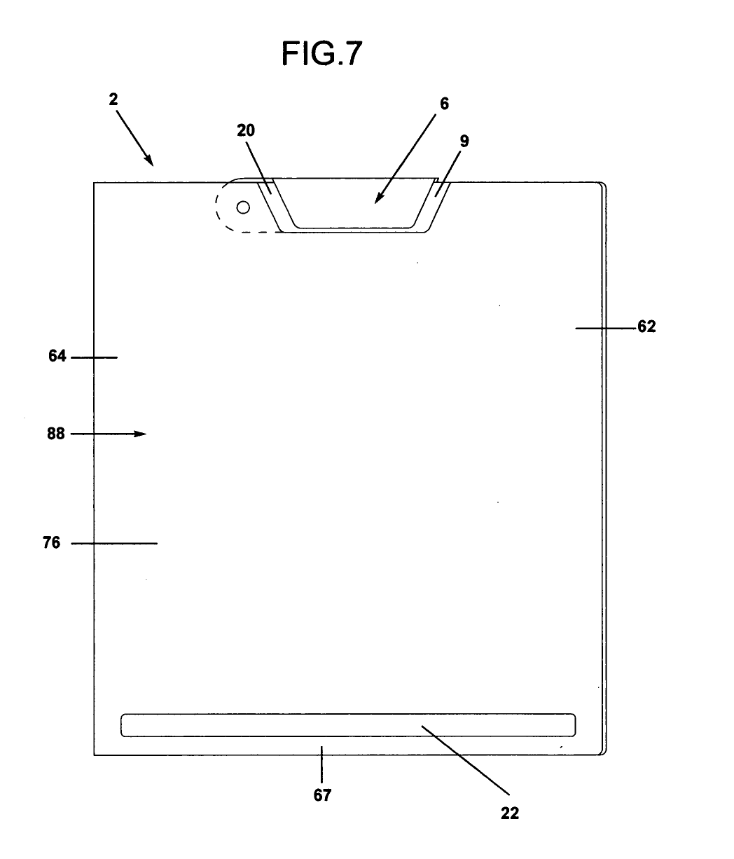

FIGS. 6 and 7 show front views of an embodiment of the invention 2 with a swing clip mechanism 6 attached directly to a binder 76 having a cover 62 with a top 66, bottom 67 and a side edge 12. The swing clip mechanism 6 is preferably attached to the cover 62 on the outside surface 64 of the cover 62. Although the clip mechanism 6 is preferably attached to the outside surface 64 of the cover 62 of the binder 76, the clip mechanism 6 could be attached to the inside surface of the cover 62 of the binder 76. Further, the swing clip mechanism 6 is preferably located at the top 66 of the cover 62 but could also be located at the bottom 67 or along the side edge 12 of the cover 62.

As mentioned above, it is common practice for a binder 76 to be made of a poly-type material 9 so a rollover tab 20 can be integrally created with the material 9 as part of the manufacturing process of the binder 76. However, as also mentioned above, the binder 76 may be made of a relatively non-slippery material and have a rollover tab 20 applied. This allows the binder 76 to be made of some of the materials listed above that, without such a rollover tab 20, wouldn't be able to effectively have a swing clip mechanism 6. The size of this binder 76 preferably matches the industry standards for a full-sized binder 76, with a breadth ranging from about 22 to 24 cm and a length of about 28 to 31 cm.

FIG. 6 shows the tab 26 for indicia 22 located on the side edge 12 of the cover 62 with the tab 26 ranging in size from about 1 cm up to about 26 cm in length depending upon design preferences and the tab 26 having an area for writing on or otherwise attaching indicia 22. Alternately, the tab 26 could be an indent in the cover 62 or along the side edge 12 of the cover 62 or be made of a different material that serves to identify where the indicia 22 can be placed or for a label attached. In FIG. 7, the area for indicia 22 is located directly on the surface of the cover 62 of the binder 76 itself and may span some or most of the length of the bottom 67 of binder 76. As a result, the area for indicia 22 here preferably has dimensions of about 1 cm up to 3 cm in length.

FIGS. 8, 9 and 10 are very similar to FIGS. 6 and 7 in that they show a binder 76 with a swing clip mechanism 6 and are of approximately the same size. The difference in FIGS. 8, 9 and 10 are that they include a cover sheet 52 that is attached to the binder 76 along a fold line 48. The size of the cover sheet 52 is typically smaller than the binder 76 with a breadth typically ranging from about 20 to 28 cm and a length of about 23 to 28 cm. Cut out of the cover sheet 52 is an area that becomes the rollover tab 20. The area for indicia 22 in this embodiment preferably spans most of the length of the binder 76 and is located on the binder cover 62 of the binder 76 so that the user can still identify the contents when the cover sheet 52 is closed.

FIG. 8 is a front view of a binder 76 with a swing clip mechanism 6 located on the front 82 of the binder 76 along a side edge 12. In the embodiment shown, the binder 76 also has a cover sheet 52.

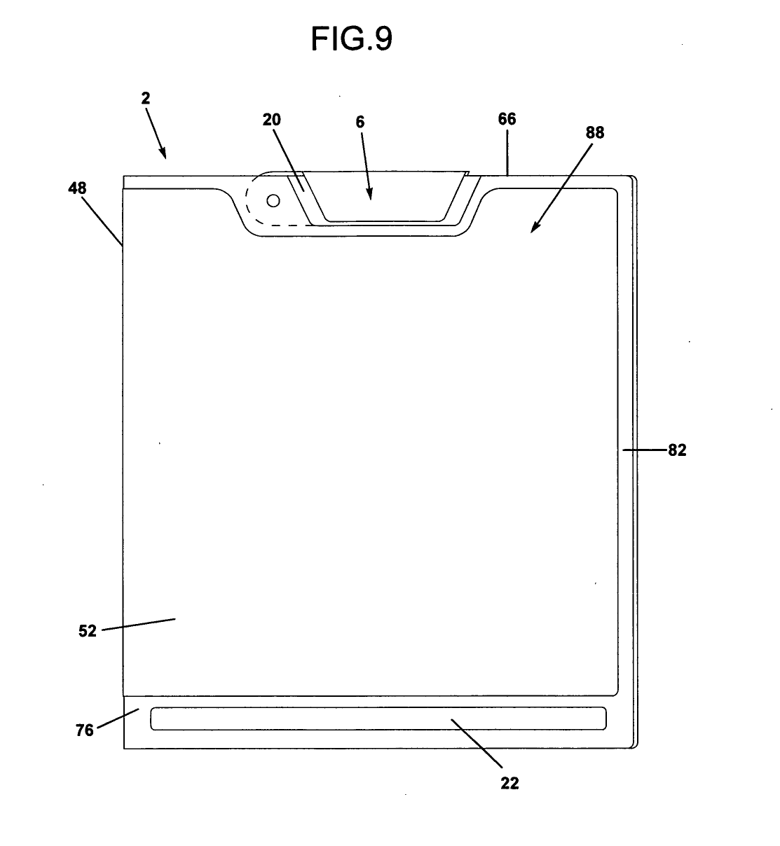

FIG. 9 shows a front view of a binder 76 with a swing clip mechanism 6 located on the front 82 of the binder 76 along the top 66. In the embodiment shown, the binder 76 also has a cover sheet 52.

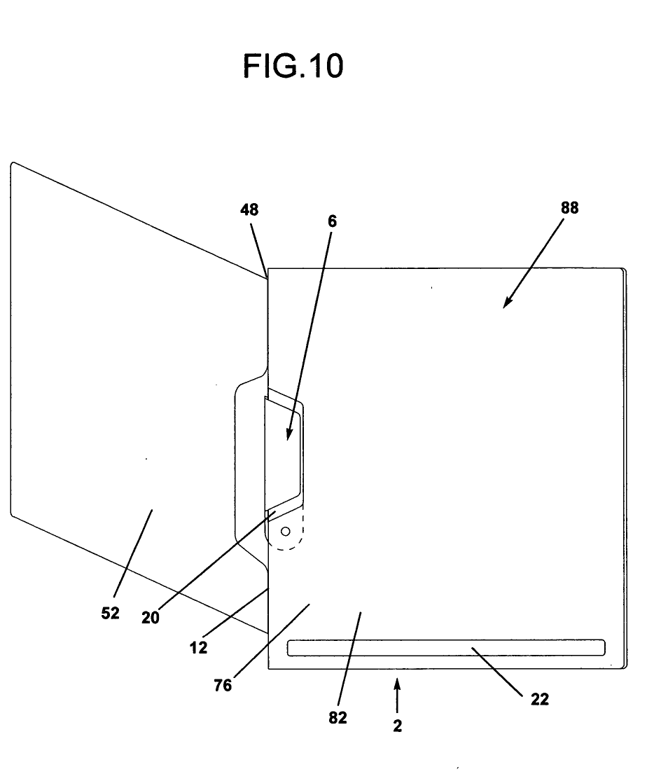

FIG. 10 is a front view of the cover sheet 52 opening from the front 82 of the binder 76. In this embodiment, the swing clip is on the side edge 12 and the binder 76 has an area for indicia 22 extending beyond the dimensions of the cover sheet 52.

The embodiments of the invention shown in FIGS. 6-10 and described immediately above include many of the same advantages of the embodiment shown in FIGS. 2-5 as described above with a few changes. The steps required to use these embodiments are reduced, as a divider pocket 50 doesn't have to be inserted into the binder 76. Because these embodiments still have the ring mechanism 56 inside, the end user can elect to secure the papers into the binder 76 when time permits. Loose papers don't have to be cleaned out of the binder 76 before organization can take place, making it easier to implement. In addition, people who receive last minute papers have a quick and easy way to secure the document to the binder 76 without the risk of losing or destroying them plus there is a place to add indicia 22. The embodiment of the invention shown in FIGS. 8-10 adds an additional cover sheet 52, for those who prefer a cover over their papers or want to single out specific documents outside and use the documents inside the binder 76 as back up.

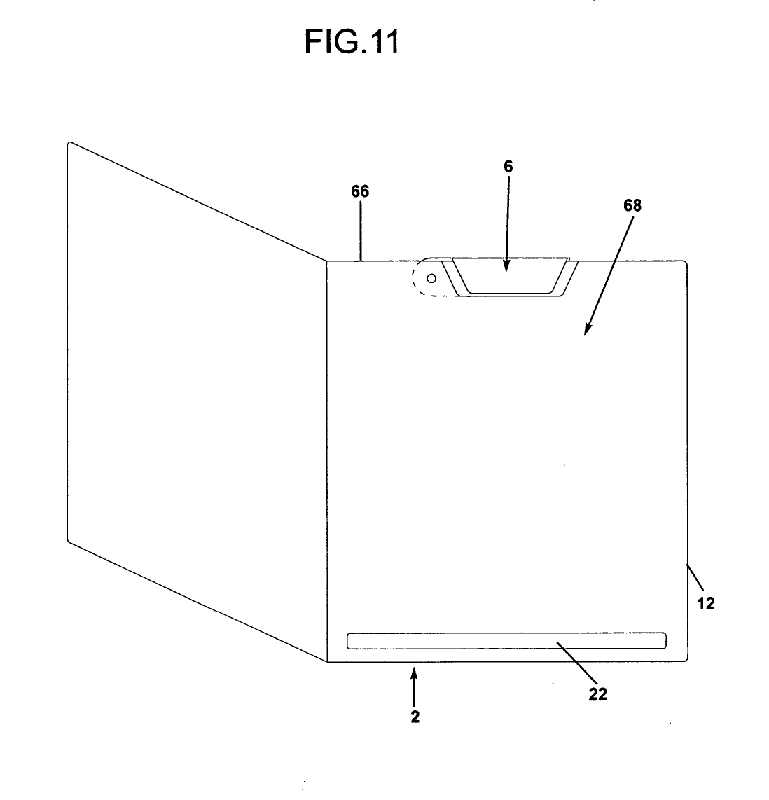

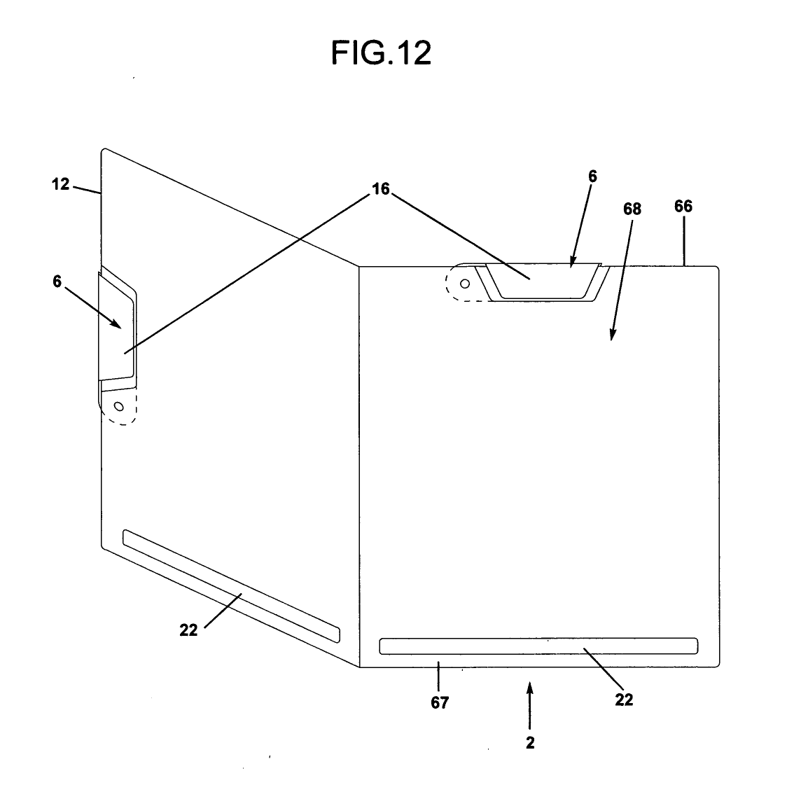

FIGS. 11 and 12 show embodiments of the invention combining a swing clip mechanism 6 with a pocket folio 68. FIG. 11 shows the pocket folio 68 open with a swing clip mechanism 6 located at the top 66 of the pocket folio 68. Although, FIG. 11 shows the pocket folio 68 open with a swing clip mechanism 6 located at the top 66 of the pocket folio 68, the swing clip mechanism 6 could also be located along the side edge 12 of the pocket folio 68.

FIG. 12 shows the same pocket folio 68 open with multiple clips 16 made up of swing clip mechanisms 6. As shown in FIG. 12, a swing clip mechanism 6 is located on the top 66 of one side of the pocket folio 68 and another swing clip mechanism 6 is located on the side edge 12 of the pocket folio 68. It is also within the scope of the invention 2 for the pocket folio 68 to have two or more swing clip mechanisms 6 located along the top 66 of the pocket folio 68 or two or more swing clip mechanisms 6 to be located along the side edge 12 of the pocket folio or virtually any combination or number of swing clip mechanisms 6 located along the top 66 or side edge 12 of this or any other embodiment shown. The measurements of the pocket folio 68 are typically similar to the binder 76: about 22 to 24 cm and a length of about 27 to 30 cm. The area for indicia 22 is preferably located on the bottom 67 of the pocket folio 68 and again preferably spans most of the length of the pocket folio 68.

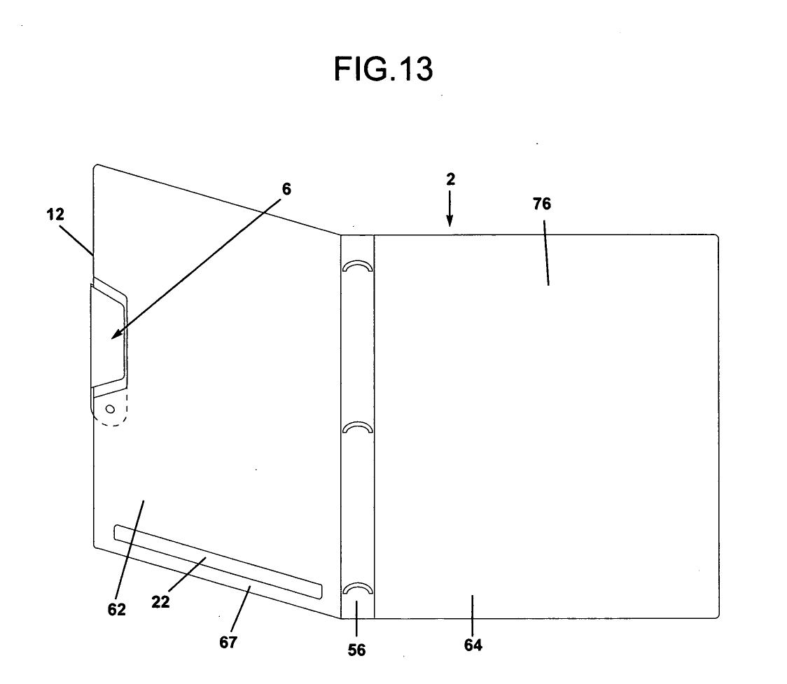

FIG. 13 shows a front view of a binder 76 with a ring mechanism 56 and with the binder 76 in an open configuration. The swing clip mechanism 6 in this embodiment is located on the inside 64 of the binder 76 along the side edge 12. This embodiment also preferably includes an area for indicia 22 located on the bottom 67 of the cover 62 which spans most of the length of the bottom. The binder 76 is preferably industry standard sizes.

The embodiment of the invention 2 having a pocket folio 68 has several advantages over traditional folders. The pocket folio 68 holds more material than a pocket 50, documents stay neatly ordered and odd sized papers can easily be included. In addition, the end user can quickly scan through the documents without having to remove or replace the papers into the folder, resulting in a decreased likelihood that the papers get lost or destroyed.

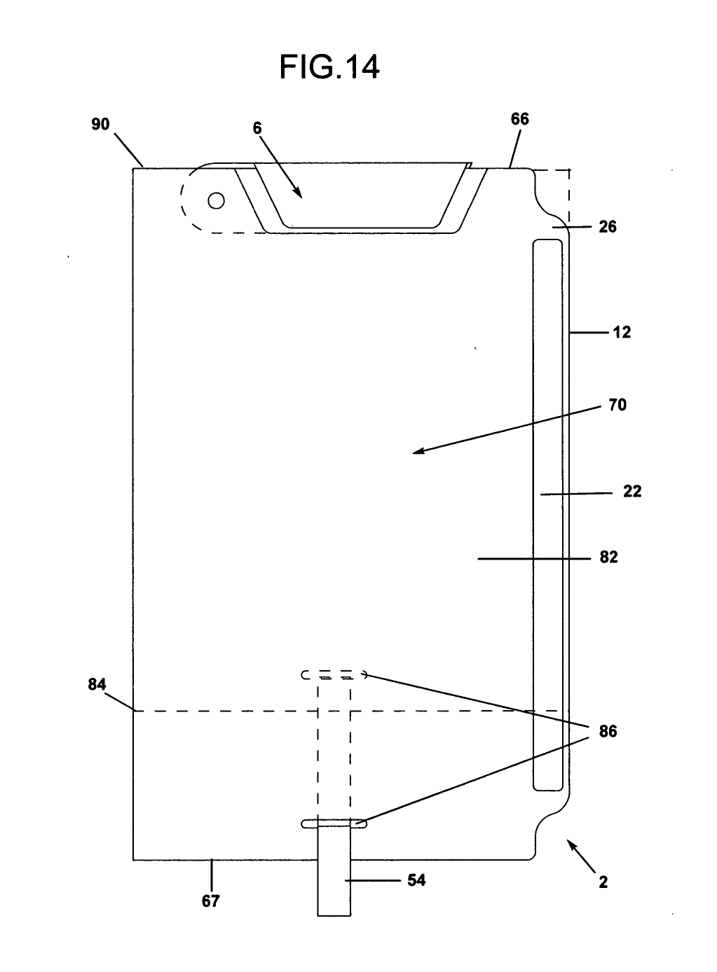

FIGS. 14, 15, 16 and 17 show an embodiment of the invention 2 combining a swing clip mechanism 6 with an adjustable book cover 70. The adjustable book cover 70 has a front 82 and a back 84 and includes a folded portion 90 connecting the front 82 to the back 84 across the top 66 of the adjustable book cover 70. The adjustable book cover 70 also includes a bottom portion 67 having a closing mechanism 54 that allows the adjustable book cover 70 to be adjusted to various size books 78. The front 82 of the adjustable book cover 70 is preferably sized anywhere from about 13 to about 21 cm in breadth. The folded portion 90 preferably has dimensions of about 0.3 to about 0.7 cm and the back 84 of the adjustable book cover 70 is preferably sized anywhere from about 13 to about 21 cm in breadth. The length of the front 82 of the adjustable book cover 70 ranges from about 17 to about 26 cm and the length of the back 84 of the adjustable book cover 70 is about 15 to about 26 cm in length. Although typical dimensions have been given, it is clear that the dimensions will have to be adjusted to cover books of non-typical dimensions as will be clear to those skilled in the art.

The closing mechanism 54 is an adjustable strap that goes through a small opening 86 of the front 82 and back 84 and is preferably made of an adjustable material such as a hook and loop fastener such as is sold under the tradename Velcro® or a stretchable elastic strap. The tab 26 on the adjustable book cover 70 shown in FIG. 14 is preferably located along the side edge 12 of the adjustable book cover 70 and preferably ranges in size from about 1 cm up to about 26 cm and the tab 26 again preferably includes an area for indicia 22. However, it is clear that the tab 26 could be located along either the top 66 or bottom 67 of the adjustable book cover 70 if desired.

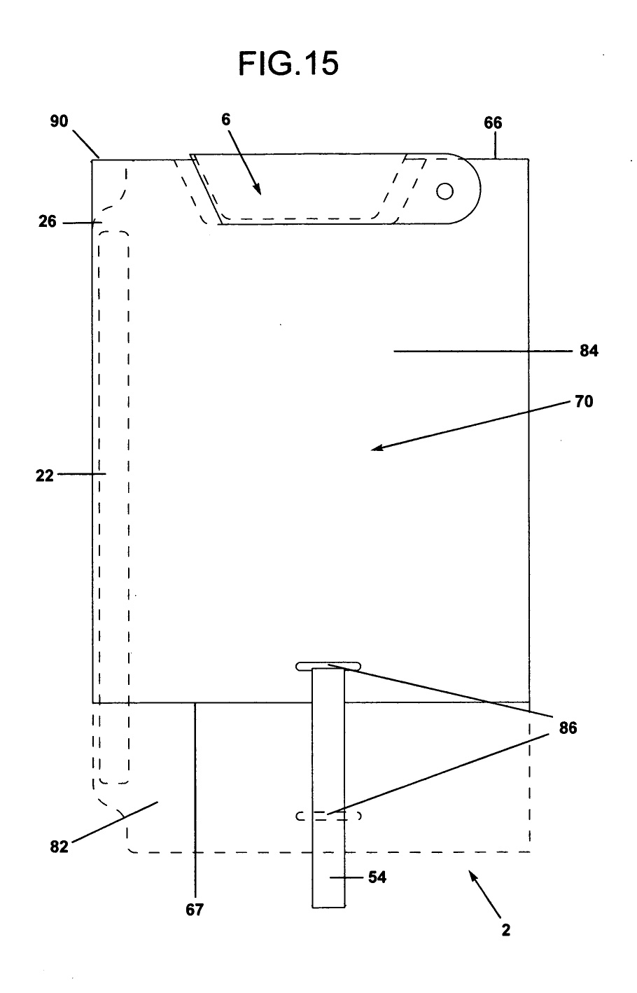

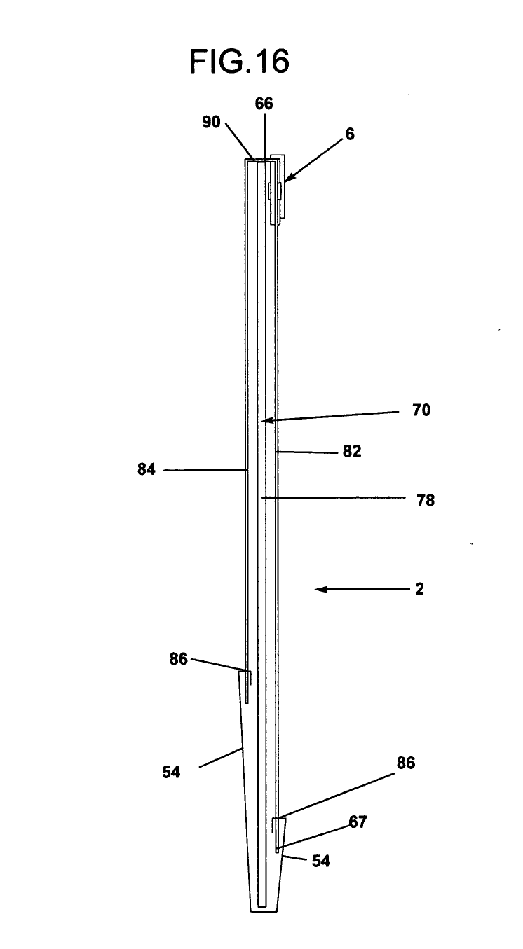

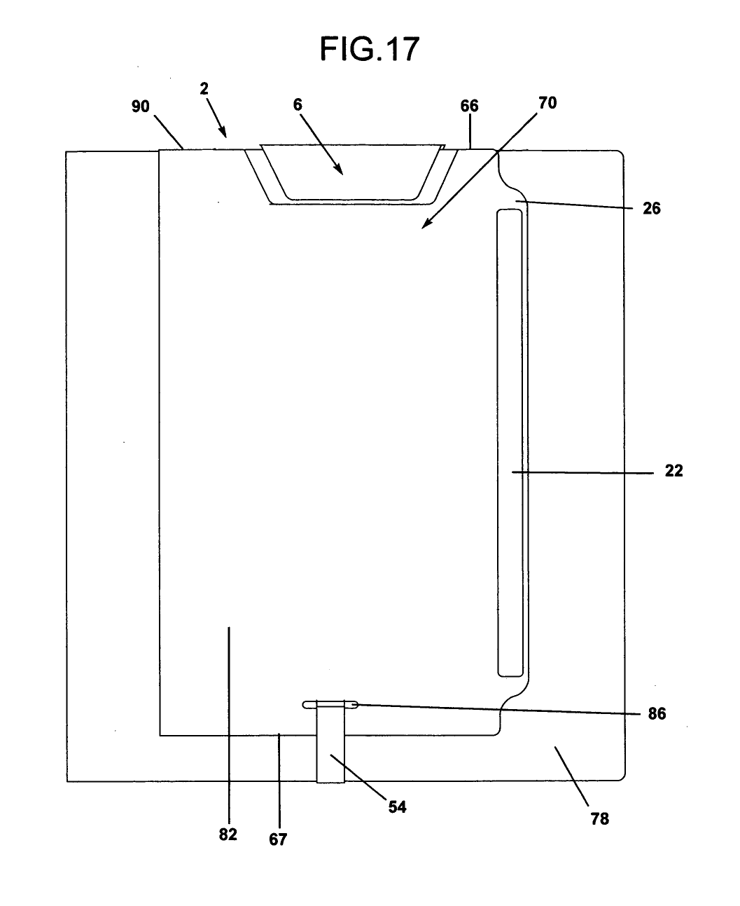

FIG. 15 is a back view of the adjustable book cover 70 and FIG. 16 is a side view of the adjustable book cover 70. FIG. 17 is a perspective view of the adjustable book cover 70 as it would appear on a book 78. To attach the adjustable book cover 70 to a book, the user slips the adjustable book cover 70 over the top of the book and then adjusts the adjustable strap to accommodate the size of the book.

The embodiment of the invention 2 shown in FIGS. 14-17 has many of the features and advantages of the other embodiments of the invention 2 listed above. The first feature that is apparent on this embodiment of the invention 2 is that the adjustable book cover 70 does not wrap completely around the book 78. Instead, the adjustable book cover 70 wraps over the top of the cover and has an adjustable strap that goes around the adjustable book cover 70 to secure to the bottom of the adjustable book cover 70. The result of this design is that the depth of the book 78 is no longer a consideration and the adjustable book cover 70 can fit on more sizes of books 78. The swing clip mechanism 6 on the front of the adjustable book cover 70 allows a person to attach papers directly to the book 78 and reduced the likelihood of the papers getting lost or destroyed. An additional feature of the swing clip mechanism 6 on the front of the adjustable book cover 70 allows the adjustable book cover 70 to double as a clipboard. Even though the book 78 is usually easily identified by its cover and spine, a space for indicia 22 is included, so the user can identify the book 78 in a way that is relevant to them.

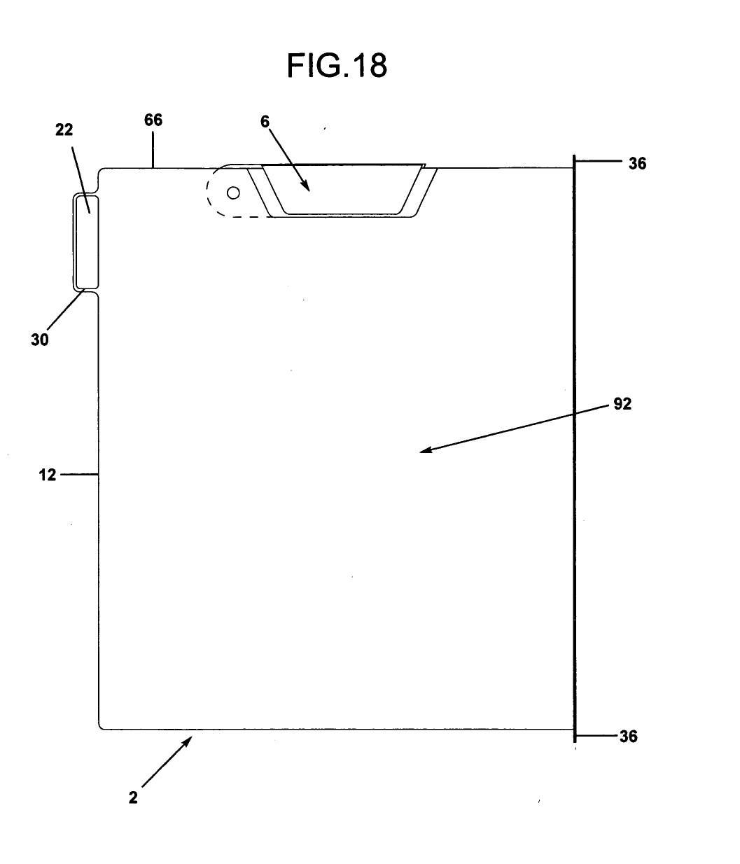

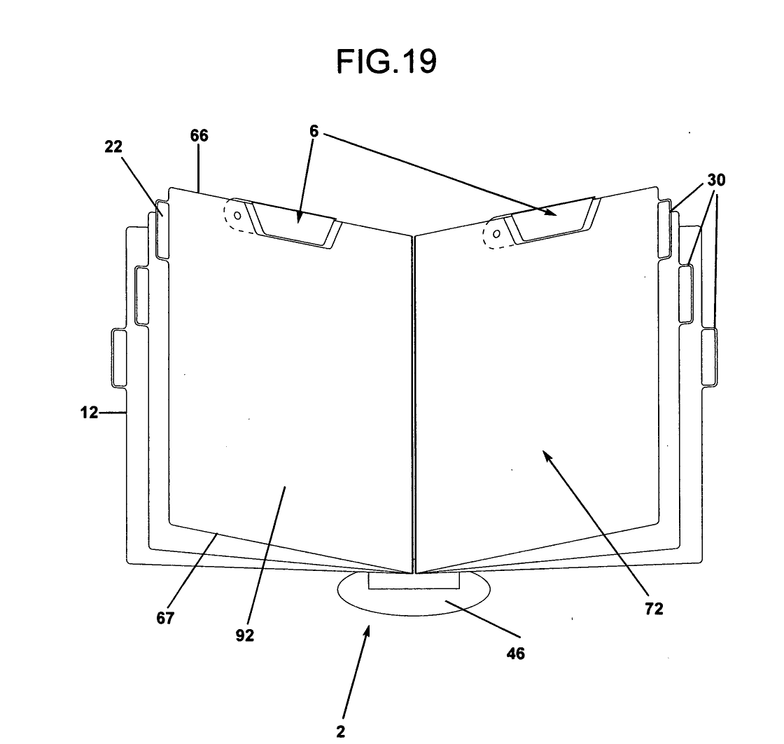

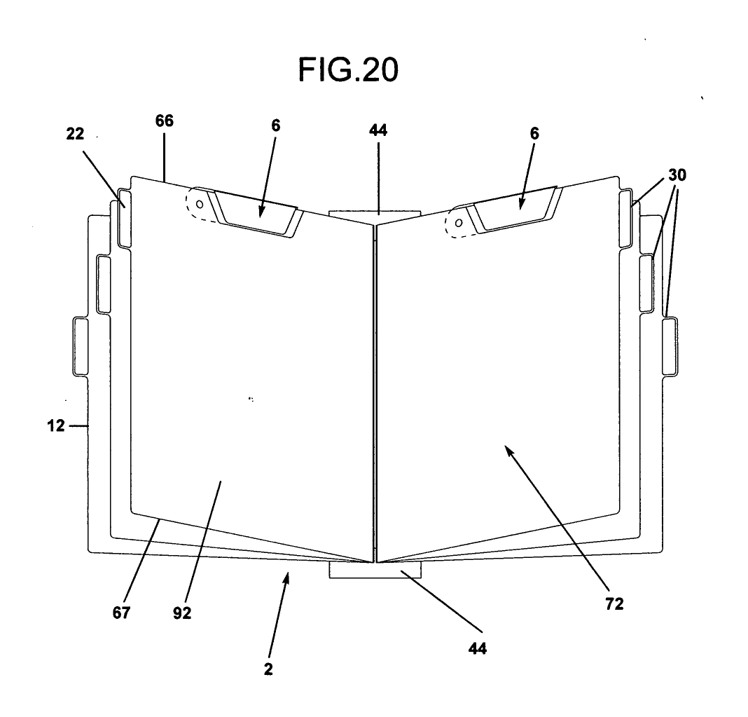

The embodiment shown in FIGS. 18, 19 and 20 combines a swing clip mechanism 6 with a multi-paged binder 72. These multi-paged binders 72 are often found in medical offices and house reference information, such as phone numbers, codes and instructions. FIG. 18 shows a single page 92 of a multi-paged binder 72 with attaching pegs 36 that are used to attach the single page 92 to the multi-paged binder 72. These single pages 92 are typically the same size as the binder pocket divider 60 with a swing clip mechanism 6 located along the top 66 of the single page 92. The side edge 12 of the single page 92 typically has staggered tabs 30 having areas for indicia 22 so that all of the various contents can be identified with indicia 22. FIG. 19 shows an embodiment of the invention 2 as it appears on a desktop stand 46 and FIG. 20 shows the wall mounted 44 version of the invention 2 according to this embodiment. Although the swing clip mechanism 6 is preferably located along the top 66 of a single page 92, it is also within the scope of the invention for a swing clip mechanism 6 to be located along a side edge 12 or bottom 67 of a single page 92 or in any combination of top 66, bottom 67 or side edge 12. Also, although the tabs 26 are preferably located along a side edge 12 of a single page 12, the tabs may be located across the top 66 or bottom 67 of a single page or in any combination of top 66 or bottom 67.

The embodiment of the invention 2 shown in FIGS. 18-20 addresses some key issues regarding ease of use. The information the user needs to access is still in a format that is readily available, but this new system makes it easy to update the information to keep the system current. And by reducing the traditional page protector sleeve, it is easier to implement the initial set up of the system. Another feature of this embodiment of the invention 2 is that more information can be included in the same amount of space. As the multi-page binder product currently exists in the market, each page only allows for one sheet of paper per side. With this embodiment of the invention 2, the end user can have multiple pages easily available for their viewing, which is especially important to visual organizers.

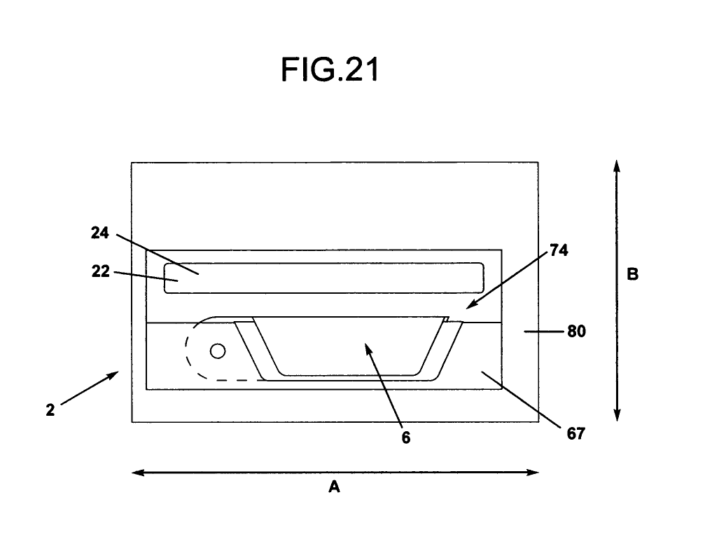

FIGS. 21, 22, 23 and 24 show a swing clip unit 74 combining a swing clip mechanism 6 and preferably an area for indicia 22 with an attaching mechanism 34 for connecting the swing clip unit 74 to a flat surface 80. The swing clip unit 74 attaches material such papers to the flat surface 80 through the swing clip mechanism 6 and attaching mechanism 34. Examples of the flat surface 80 include, but are not limited to, a magnetic surface, a bulletin board or the front of an already existing unit such as walls, dividers, poles, bookcases, filing cabinets, portable closets, desks, desktop sorters, file folder or bookends to give but a few possible examples. The components that make up the swing clip unit 74 are shown in FIG. 21: a swing clip mechanism 6, preferably an area for indicia 22 and more preferably with a write and erase surface 24 and an attaching mechanism 34 for connecting the swing clip unit 74 to a flat surface 80.

The swing clip unit 74 typically has dimensions of about 10 cm up to about 23 cm in width “A,” a height “B” of about 3 cm to about 10 cm and a depth “C” of less than about 2 cm. The front 82 of the swing clip mechanism 6 has a protruding breadth 58 of typically about 1 to about 3 cm where the swing clip mechanism 6 is attached to allow space for the user to easily open the swing clip mechanism 6.

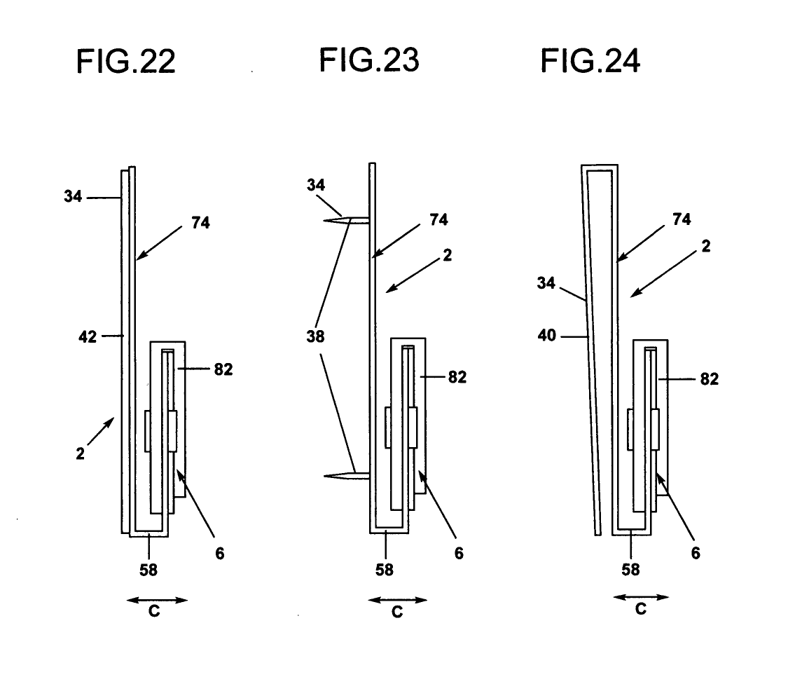

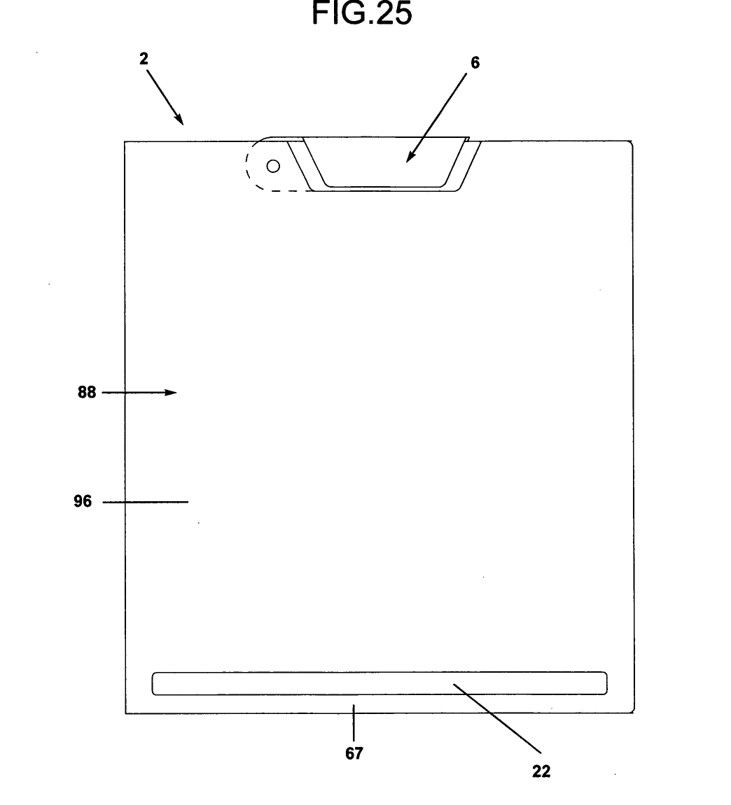

FIG. 22 shows a side view of the swing clip 74 with the attaching mechanism 34 being a magnetic backing 42 that is attached to the swing clip mechanism 6 and area for indicia 22 by means well understood in the art including but not limited to adhesives, rivets, screws, nuts and bolts and physical restraint. FIG. 23 shows an embodiment of the invention 2 with the attaching mechanism 34 taking the form of attaching pins 38 protruding from the back 84 of the swing clip unit 74 for use on a bulletin board by impinging into and being frictionally constrained in contact with the bulletin board. FIG. 24 shows an embodiment of the invention 2 with the attaching mechanism 34 taking the form of an attaching clip 40 for securing the swing clip unit 74 onto a pre-existing item. Specific forms of attaching clips are well known in the art for attaching items such as lights, fans, speakers and other office or home devices to items such as walls, dividers, poles, bookcases, filing cabinets, portable closets, desks, desktop sorters, file folder or bookends. In the embodiments shown in FIGS. 23 and 24, the attaching mechanisms 34 may be attached to the swing clip mechanism 6 and area of indicia 22 by means including, but not limited to, adhesives, rivets, screws, nuts and bolts and physical restraint.

The embodiment of the invention 2 shown in FIGS. 21-24 has been described heretofore primarily as allowing a swing clip mechanism 6 to be attached to a flat surface 80 through the use of a swing clip unit 74. But, it is clear that the swing clip unit 74 may be attached to objects that are not flat through an attachment clip 40 such as that shown or otherwise well known in the art or by forming the backing, such as magnetic backing 42, in a conformal shape to a desired non-flat surface or by positioning the attaching pins 38 in a configuration to allow the attaching pins 38 to anchor or otherwise to allow the swing clip unit 74 to be attached to objects that are not flat.

The embodiment of the invention 2 shown in FIGS. 21-24 and described above also has many features and advantages. The variations of this embodiment of the invention 2 are designed so that the swing clip mechanism 6 holds multiple papers, are easily attachable to their appropriate surface such as flat surface 80, simple to use so they are simple to update and there is a place for indicia 22. The magnetic version doesn't require the user to remove the magnetic portion from the surface it is on. The push pin version, for use on a pliable surface such as cork, allows for many more papers to be visible and reduced the cluttered “one-on-top-of-another” syndrome. The clip on version allows the end user to use the product in a variety of environments.

FIG. 25 shows another embodiment of the invention 2 where a swing clip mechanism 6 is attached to a standard clipboard 96. In this embodiment of the invention 2, the clipboard 96 has a top 66, bottom 67, side edge 12, front 82 and back 84. The swing clip mechanism 6 is preferably located on the top 66 but may also be located on the bottom 67 or side edge 12 on either the front 82 or back 84 of the clipboard.

The invention has been described in connection with the combination of a swing clip mechanism 6 with a device for locating paper or similar elements such as binder pocket divider 60, binder cover 62, pocket folio 68, adjustable book cover 70, multi-paged binder 72, attachable unit 74 or clipboard 96. But, it is to be understood that these device for locating paper or similar elements are illustrative of the invention 2 and are not intended to limit the scope of the invention 2 to these specific devices. Instead, any device that locates paper or similar elements as that term is described below is intended to be within the scope of the invention.

The invention 2 as described heretofore has been primarily in the form of an apparatus for organizing papers and similar elements. However, the invention also include a method of organizing papers and similar elements. This method comprising the steps taking a device for locating paper or similar elements such as binder pocket divider 60, binder cover 62, pocket folio 68, adjustable book cover 70, multi-paged binder 72, attachable unit 74 or clipboard 96 and attaching a swing clip mechanism 6 to secure the paper or similar elements to the device for locating paper or similar elements. “Locating paper or similar elements” means to set or establish the paper or similar elements in a particular spot, e.g., on or in the device for locating paper or similar elements or by the device for locating paper or similar elements with respect to a fixed location such as a magnetic surface, a bulletin board or the front of an already existing unit such as walls, dividers, poles, bookcases, filing cabinets, portable closets, desks, desktop sorters, file folder or bookends. In this way, the inherent organizing capacity of the device for locating paper or similar elements is improved and enhanced.

The present invention has been described in connection with certain embodiments, configurations and relative dimensions. However, the description above is not to be construed as being limited to the particular embodiments or dimensions described. It is to be understood that the description given herein has been given for the purpose of explaining and illustrating the invention and are not intended to limit the scope of the invention.

For example, where tabs 26 are shown or described as being in a particular location, such tabs 26 may be located in other locations as described in the specification, or in multiple locations or in numbers greater than one in different or multiple locations and with or without areas for indicia 22 and with or without a write and erase surface 24 on one or more such areas for indicia 22. Further, differing numbers of rings in or types of closing mechanisms 54, where described, are also intended to be included in the invention. In addition, it is clear that more than one swing clip mechanism 6 may be located on a device of the invention 2 according to the teachings of this description or that multiple embodiments of the invention 2 may be combined into a single device. Also, there are many materials and configurations that can be used in constructing the invention by those skilled in the art including those being developed or that will be developed. In addition, it is clear than an almost infinite number of minor variations to the form and function of the disclosed invention could be made and also still be within the scope of the invention. Consequently, it is not intended that the invention be limited to the specific embodiments and variants of the invention disclosed. It is to be further understood that changes and modifications to the descriptions given herein will occur to those skilled in the art. Therefore, the scope of the invention should be limited only by the scope of the claims.

I claim:

1. A device for organizing paper comprising:
a device for locating paper or similar elements, the device having a top, bottom and a side edge; and
at least one swing clip attached to the device for locating paper or similar elements, the swing clip being movable between a clamping and an open position to secure the paper to the device for locating paper or similar elements.

2. The device of claim 1 wherein the device for locating paper or similar elements is chosen from the group consisting of a binder pocket divider, binder cover, pocket folio, adjustable book cover, multi-paged binder, attachable unit or clipboard.

3. The device of claim 1 wherein the device comprises at least two swing clips attached to the device for locating paper or similar elements, each swing clip being movable between a clamping and an open position to secure the paper to the device for locating paper or similar elements.

4. The device of claim 1 further comprising a first tab for locating indicia that serves as a visual cue reminding the user of the content of the device.

5. The device of claim 4 wherein the first tab is located on either the top, bottom or side edge of the device for locating paper or similar elements.

6. The device of claim 5 wherein the first tab further includes a write and erase surface for writing on to indicate the contents of the documents stored in the device for locating paper or similar elements.

7. The device of claim 4 further comprising a second tab wherein the first tab is located on one of a top, bottom or side edge of the device for locating paper or similar elements and the second tab is also located on one of a top, bottom or side edge of the device for locating paper or similar elements.

8. The device of claim 2 wherein the device for locating paper or similar elements is a binder pocket divider having a top, a bottom, a side edge, a front and a back and a pocket and wherein the swing clip is attached to either the top, bottom or side edge of the binder pocket divider.

9. The device of claim 8 wherein the pocket is located on either the front or back or both of the binder pocket divider.

10. The device of claim 2 wherein the device for locating paper or similar elements is a binder having a cover with a top, a bottom and a side edge wherein the swing clip is attached to either the top, bottom or side edge of the cover of the binder.

11. The device of claim 2 wherein the device for locating paper or similar elements is a binder having a top, a bottom, a side edge and a cover sheet attached to the binder along a fold line wherein the swing clip is attached to either the top, bottom or side edge of the cover of the binder.

12. The device of claim 2 wherein the device for locating paper or similar elements is a multi-page binder having at least one single page having a top, a bottom and a side edge wherein the swing clip is attached to either the top, bottom or side edge of the single page.

13. The device of claim 2 wherein the device for locating paper or similar elements is a pocket folio having a top, bottom and a side edge wherein the swing clip is located on either a top, bottom or a side edge of the binder.

14. The device of claim 2 wherein the device for locating paper or similar elements is an adjustable book cover having a top, bottom, side edge, front, back, a folded portion connecting the front to the back across the top of the adjustable book cover and a closing mechanism that allows the adjustable book cover to be adjusted to various size books wherein the swing clip is located along either a top, bottom or a side edge of the adjustable book cover.

15. The device of claim 14 wherein the front and the back of the adjustable book cover each have a small opening, wherein the adjustable strap passes through the small openings in the front and back of the adjustable book cover and wherein the adjustable strap is made of an adjustable material chosen from the group consisting of a hook and loop fastener and a stretchable elastic strap.

16. The device of claim 2 wherein the device for locating paper or similar elements is an attaching mechanism for connecting the swing clip to a flat surface.

17. The device of claim 16 wherein the attachment mechanism is chosen from the group consisting of a magnetic backing, attaching pins and an attaching clip for securing the swing clip unit onto a pre-existing item.

18. A device for organizing paper comprising:
a device for locating paper or similar elements, the device having a top, bottom and a side edge wherein the device for locating paper or similar elements is chosen from the group consisting of a binder pocket divider, binder cover, pocket folio, adjustable book cover, multi-paged binder, attachable unit or clipboard;
at least one swing clip attached to the device for locating paper or similar elements, the swing clip being movable between a clamping and an open position to secure the paper to the device for locating paper or similar elements; and
a first tab for locating indicia that serves as a visual cue reminding the user of the content of the device.

19. A method of organizing paper or similar elements comprising the steps of:
providing a device for locating paper or similar elements; and
attaching a swing clip mechanism to secure the paper or similar elements to the device for locating paper or similar elements.

20. The method of claim 19 wherein the step of providing a device for locating paper or similar elements includes the step of providing a device for locating paper or similar elements chosen from the group consisting of a binder pocket divider, binder cover, pocket folio, adjustable book cover, multi-paged binder, attachable unit or clipboard.
